(19) United States
(12) Patent Application Publication
(10) Pub. No.: US 2026/0355785 A1
(43) Pub. Date: Nov. 12, 2026

(54) SCREENING MACHINE

(71) Applicant: KOMPLET S.P.A., Trecastelli (AN) (IT)

(72) Inventors: Alan CANESTRARI, Senigallia (AN) (IT); Paolo FILONZI, Jesi (AN) (IT)

(21) Appl. No.: 19/670,098

(22) Filed: May 7, 2026

(30) Foreign Application Priority Data
May 9, 2025 (IT) 102025000010440

(51) Int. Cl. B07B 1/22; B07B 1/42

(52) U.S. Cl. CPC B07B 1/22; B07B 1/42

(57) ABSTRACT

A screening machine comprises a plurality of screening modules, each one having lateral supports and rollers rotatably mounted between the two lateral supports. The screening machine comprises two movable bulkheads, each one being hinged about a rotation axis located above the lateral support of the at least one screening module; wherein each movable bulkhead can rotate between a lowered position, wherein the movable bulkhead does not touch the lateral support and is positioned vertically to cover both the lateral support and the space formed between the lateral support and the axis of rotation, and a raised position, wherein the movable bulkhead is inclined and protrudes outwardly, leaving free access to both the lateral support and the space formed between the lateral support and the axis of rotation.

### CROSS-REFERENCE TO RELATED APPLICATIONS

Not applicable.

### FIELD OF THE INVENTION

The present invention relates to an improved screening machine.

### BACKGROUND OF THE INVENTION

Screening machines for screening and sorting materials, such as rocks, aggregates, wood, and any other material, are known in the prior art.

By way of example, a conventional screen is disclosed in EP3996854B1.

The screen described in EP3996854B1 comprises:
a fixed frame having two side members parallel to each other, at the ends of which vertical guides are positioned;
one or more screen modules detachably connected to the frame; each screen module comprises two lateral supports positioned above the lateral members of the fixed frame and a plurality of parallel, spaced-apart rotating rollers, each rotating roller being provided with screening means; the rotating rollers provided with the screening means define a screening surface of the screen;
gears associated with the rollers, which are positioned externally to one of the two lateral supports and rotated by drive chains powered by motors;
two movable lateral bulkheads mounted to slide up and down on the vertical guides of the frame between a raised position and a lowered position; and
actuators connected to the vertical walls to move the vertical walls up and down.

The lateral supports of each module lie on the lateral members and are centered relative to the lateral members by means of slots formed in the supports and projections formed on the lateral side members suitable for engaging with one another.

When the vertical walls are lowered, each vertical wall presses the support of the underlying module downwardly, thereby securing it to the underlying lateral member. Furthermore, when the lateral wall is lowered, it covers the support externally so that the gears, drive chains, and motors are not accessible from the outside.

Conversely, when the movable lateral walls are raised, a user can inspect the external supports, gears, and motors and release the modules simply by lifting them enough to disengage the slots provided on the supports from the projections formed on the lateral members of the fixed frame.

Although it greatly facilitates the disassembly and reassembly of the screening modules on the fixed frame, the screen described in EP3996854B1 is not free of drawbacks.

In particular, the screen described in EP3996854B1 is impaired by a drawback that arises when the vertical lateral wall is in raised position.

When the vertical lateral wall is in raised position, a small space is provided between the upper edge of the modules and the lower edge of the vertical lateral wall, preventing a user from reaching into the screening surface with their arms to remove, for example, any materials that are stuck between the screening means, blocking the rollers of the screen.

In the screen described in EP3996854B1, if one wishes to extract such products stuck between the screening means, it is necessary to extract the entire module from the fixed frame of the screen and then remove the products stuck between the screening elements from the screen module.

It is immediately apparent that having to extract the entire module in order to remove the elements stuck between the screening means is a rather inconvenient, slow, and complicated solution.

If one were to desire more space between the upper edge of the module supports and the lower edge of the vertical lateral wall, when the vertical lateral wall is in raised position, one could consider providing the screen with very long vertical guides and drive means capable of moving the vertical lateral walls along very long vertical travels.

The provision of such very long guides and of the drive means configured in such a way that the vertical lateral walls can move up and down along very long vertical travels significantly increases the cost and complexity of the screen.

CN110548668A describes an environmentally-friendly machine for the restoration of land containing construction debris.

US4311242A discloses a bearing cartridge support for roller screens and the like.

CN209829485U discloses a potato sorting machine with adjustable sorting gap.

### SUMMARY OF THE INVENTION

The purpose of the present invention is to provide a new screening machine comprising innovative movable lateral walls that are simple to manufacture and that, at the same time, allow a user to access the screening surface of the machine when said movable lateral walls are in raised position.

A further purpose of the present invention is to provide a screening machine that is economical and simple to manufacture.

Yet another purpose of the present invention is to provide a screening machine provided with one or more replaceable screening modules.

These objectives are achieved in accordance with the invention with the features listed in independent claim 1.

Advantageous embodiments are set forth in the dependent claim(s).

The screening machine according to the invention is defined by claim 1.

### BRIEF DESCRIPTION OF DRAWINGS

For greater clarity, the description of the screening machine according to the invention continues with reference to the attached drawings, which are for illustrative purposes only and are not limiting.

FIGS. 1 and 2 are two partial axonometric views of a first side of the screening machine illustrating a first movable wall in lowered and raised position, respectively.

FIGS. 3 and 4 are two partial axonometric views of a second side of the screening machine illustrating a second movable wall in lowered and raised position, respectively.

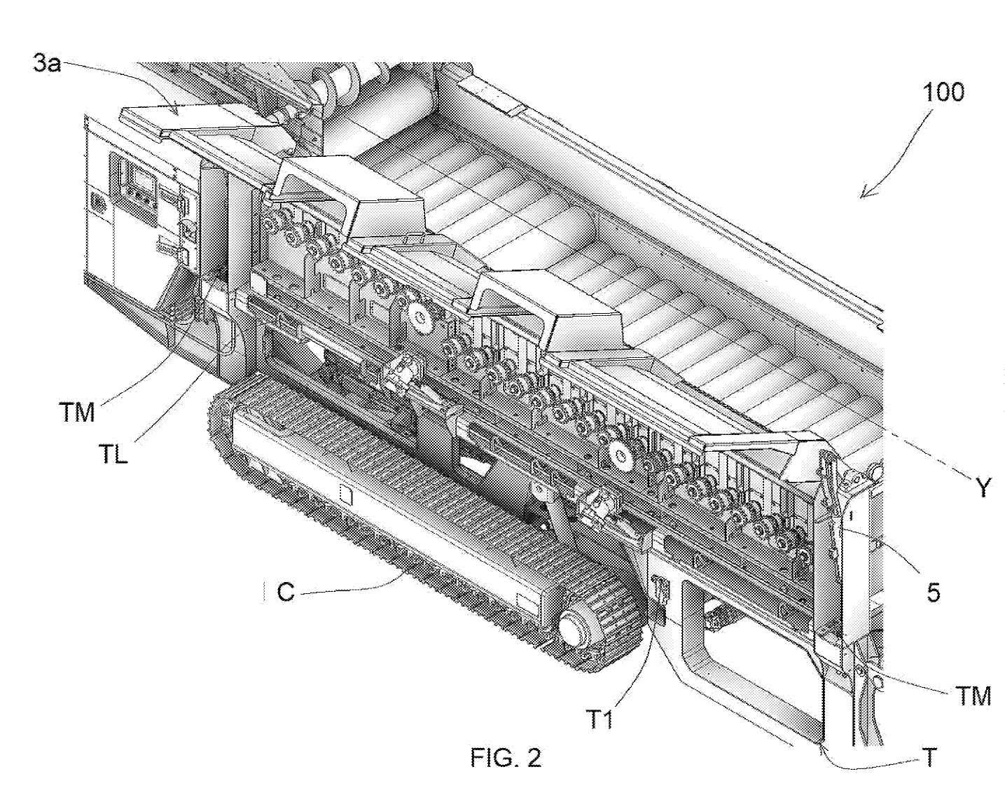

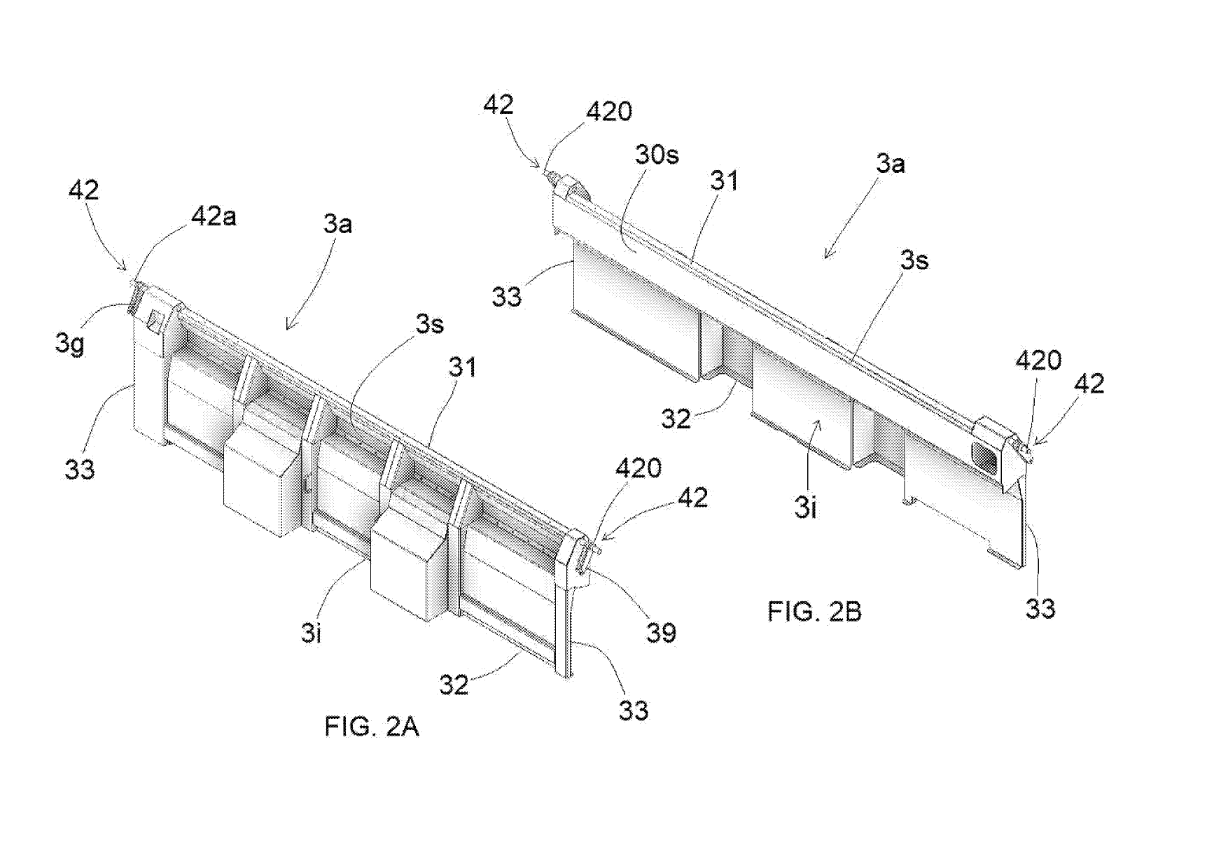

FIGS. 2A and 2B are axonometric views of the first movable wall of the screening machine.

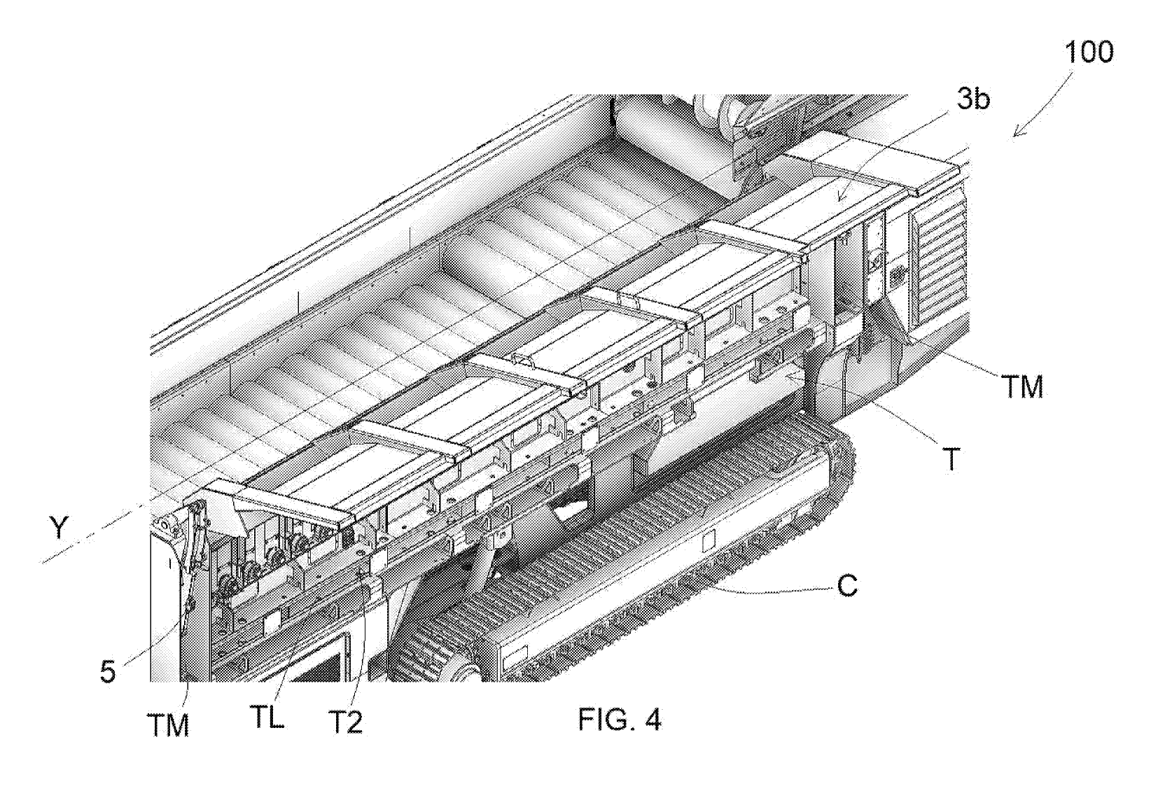

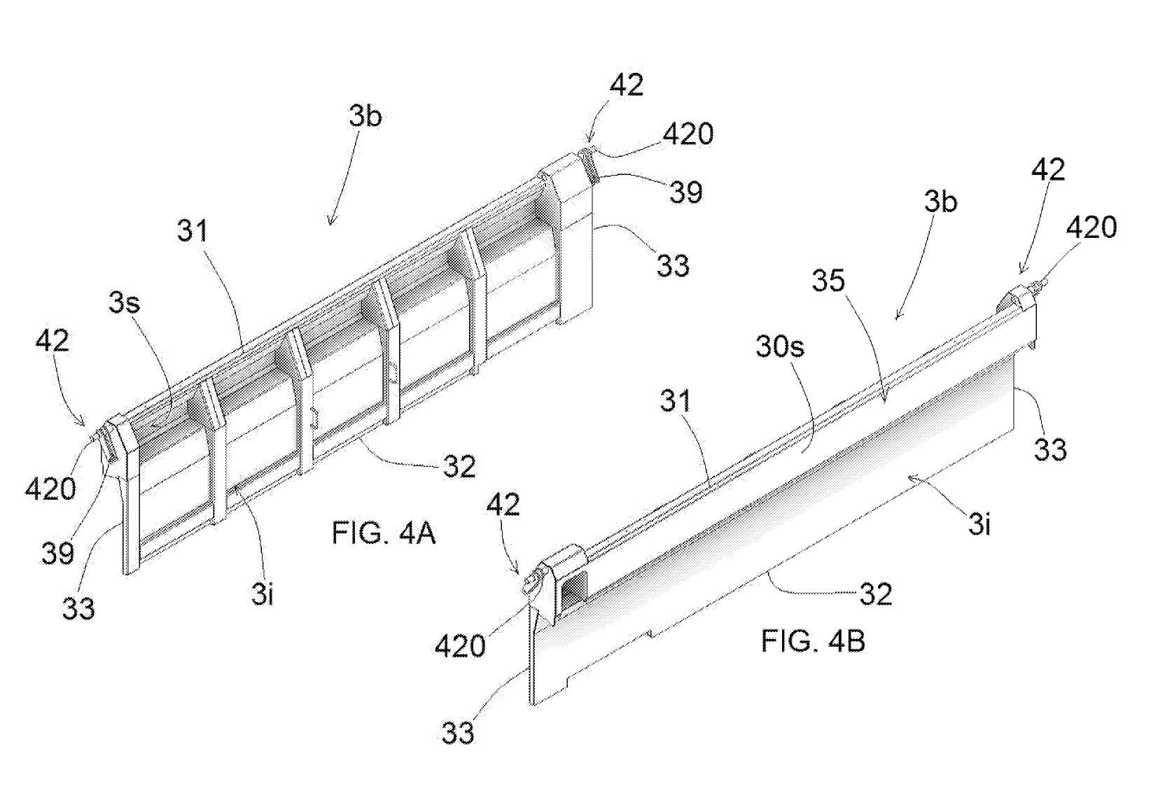

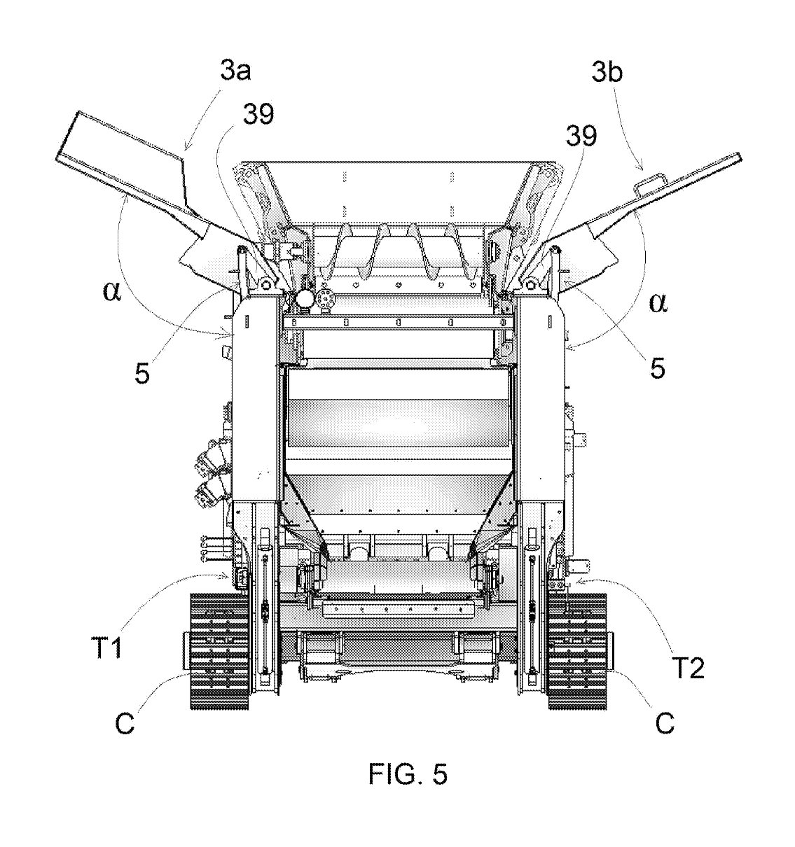

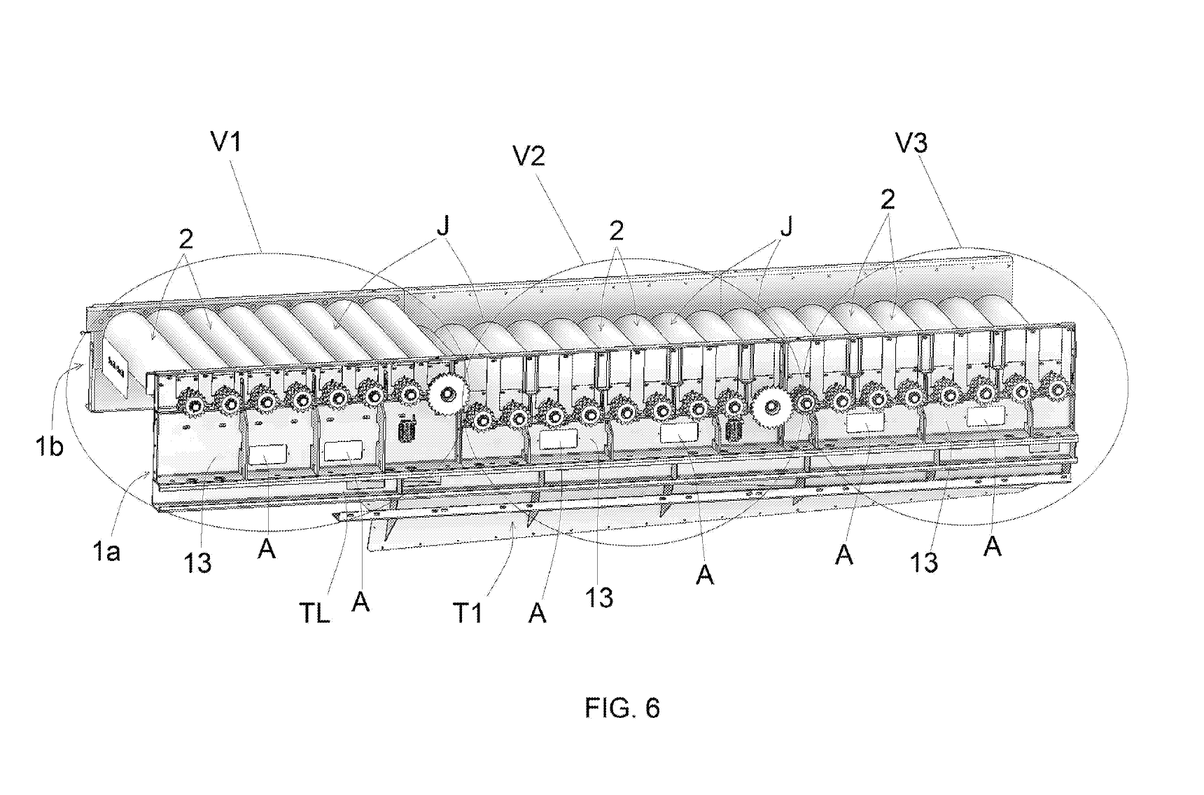

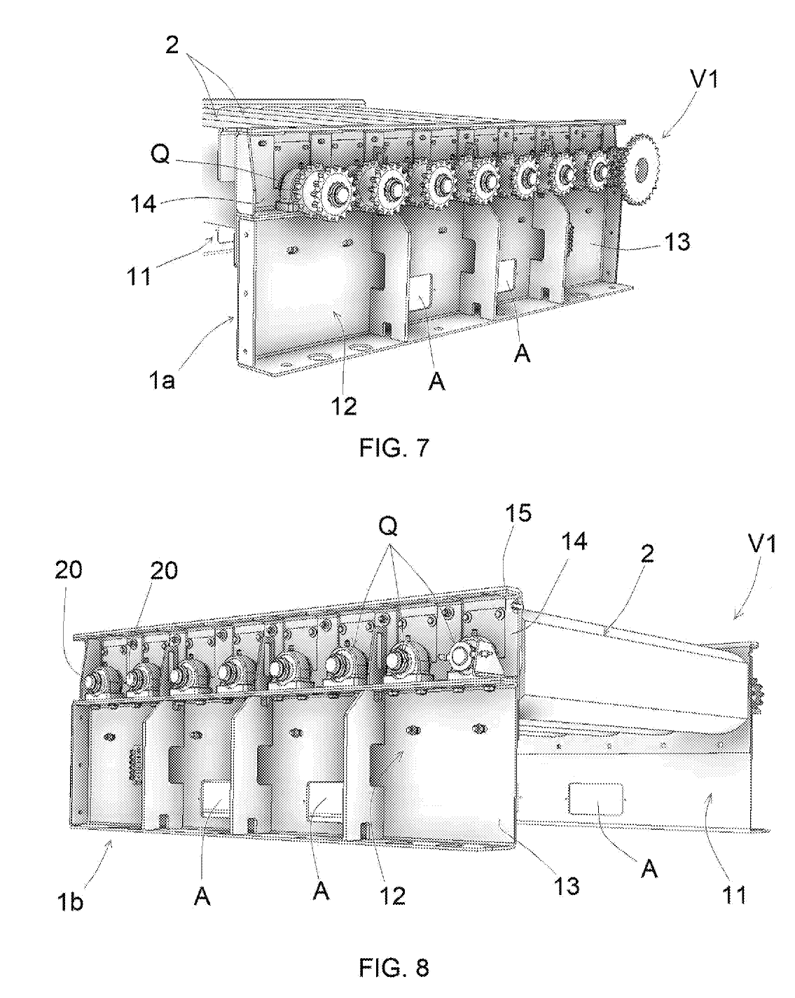

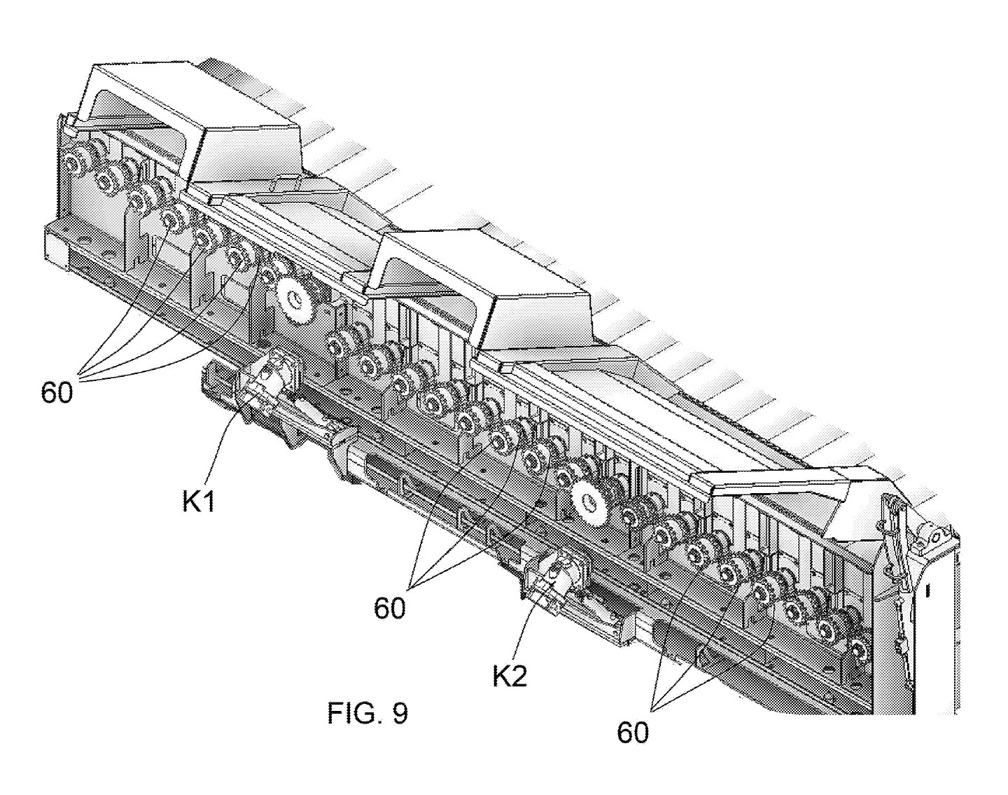

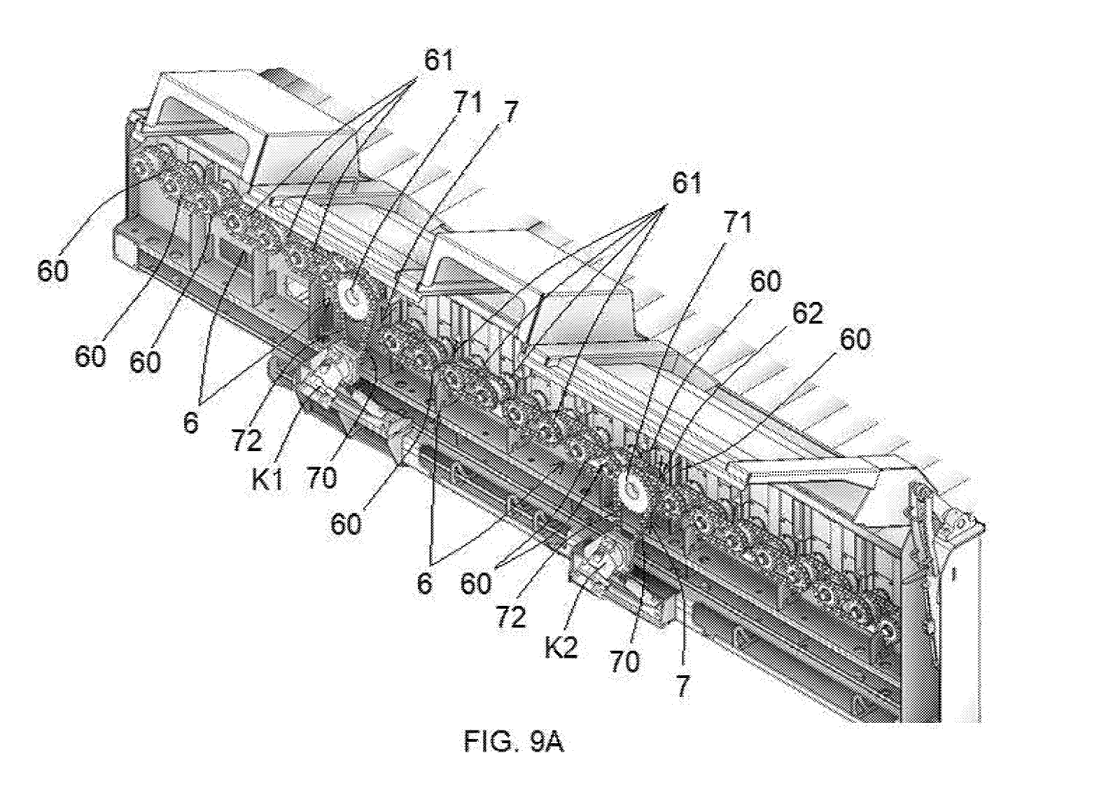

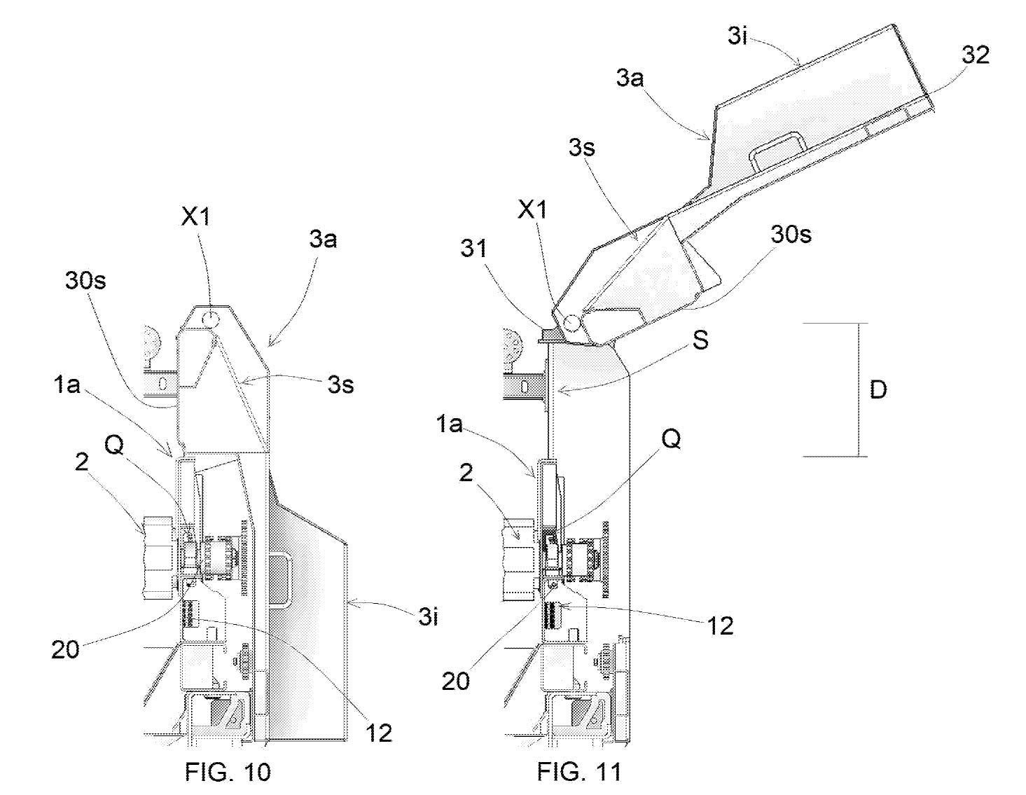

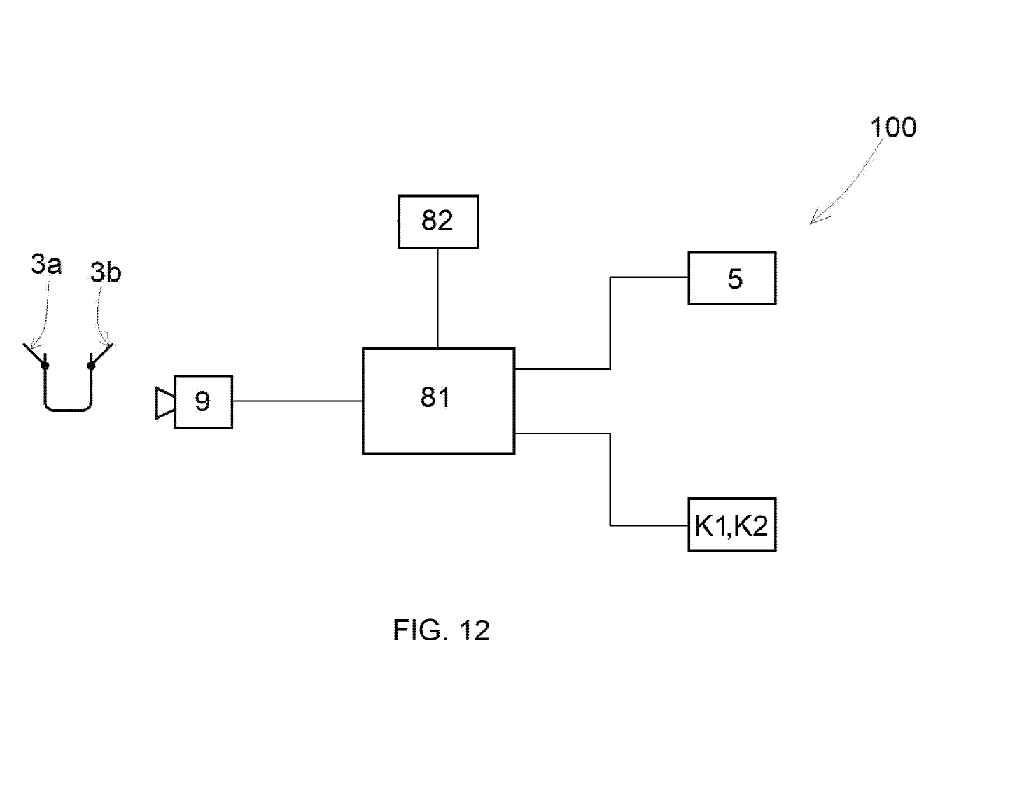

FIGS. 4A and 4B are axonometric views of the second movable wall of the screening machine.

FIG. 5 is a front view of the screening machine with the two movable walls in raised position.

FIG. 6 shows a plurality of screening modules arranged one after another on the fixed frame of the screening machine.

FIGS. 7 and 8 are axonometric views of a module of the screening machine according to the invention seen from different angles.

FIG. 9 is an enlargement of a detail from FIG. 2.

FIG. 9A is identical to FIG. 7 but supplemented with flexible transmission means of the screening machine.

FIGS. 10 and 11 are diagrammatic vertical section views of a movable wall of the screening machine positioned in lowered and raised position, respectively.

FIG. 12 is a block diagram illustrating the devices and components of the screening machine according to the invention that are operatively connected to one another.

### DETAILED DESCRIPTION OF THE INVENTION

With reference to the attached figures, a screening machine is described, referred to with numeral “100”.

The screening machine (100) is suitable for being fed with a mass of heterogeneous materials in terms of size and shape. By way of example, the screening machine (100) is fed with boulders, rocks, inert material, wood, or any other material suitable for being screened.

The screening machine (100) is suitable for separating such a mass of heterogeneous material into different fractions of material that differ from one another in terms of size or granulometry.

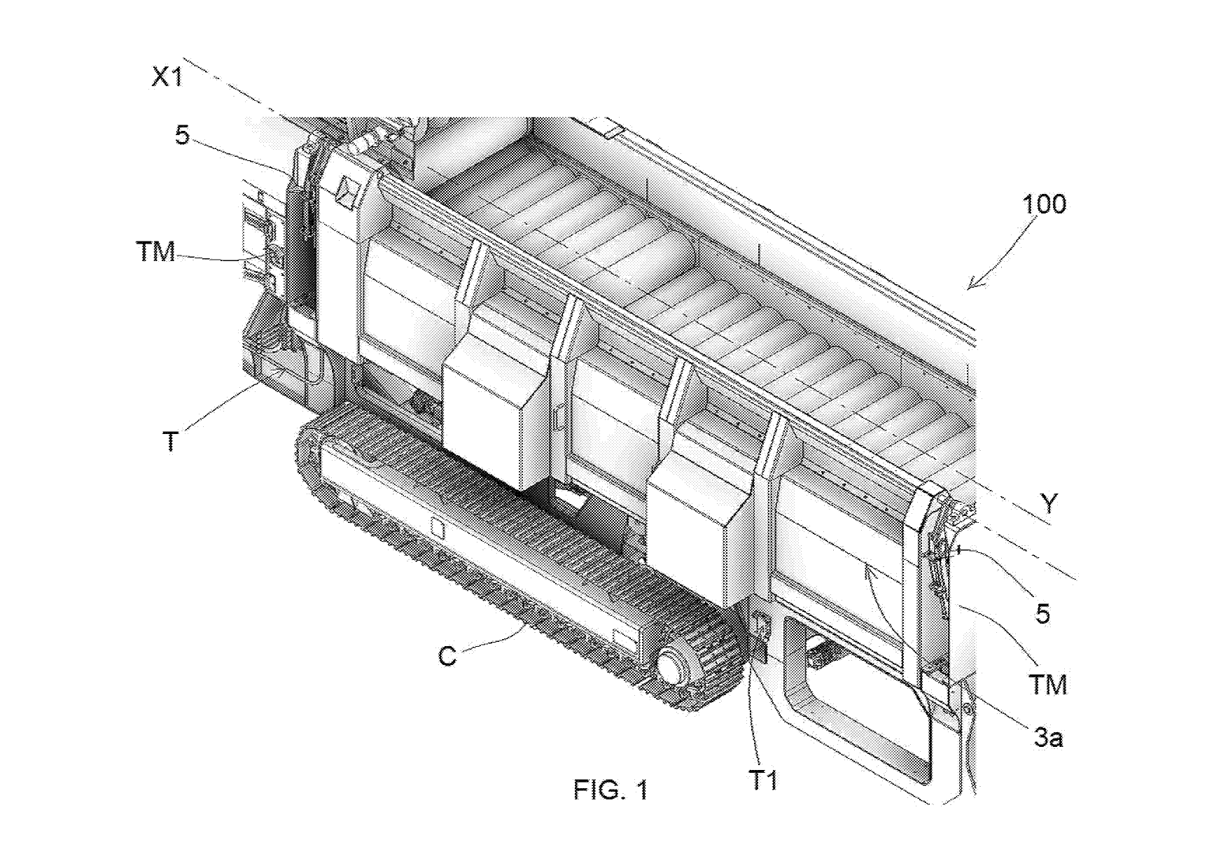

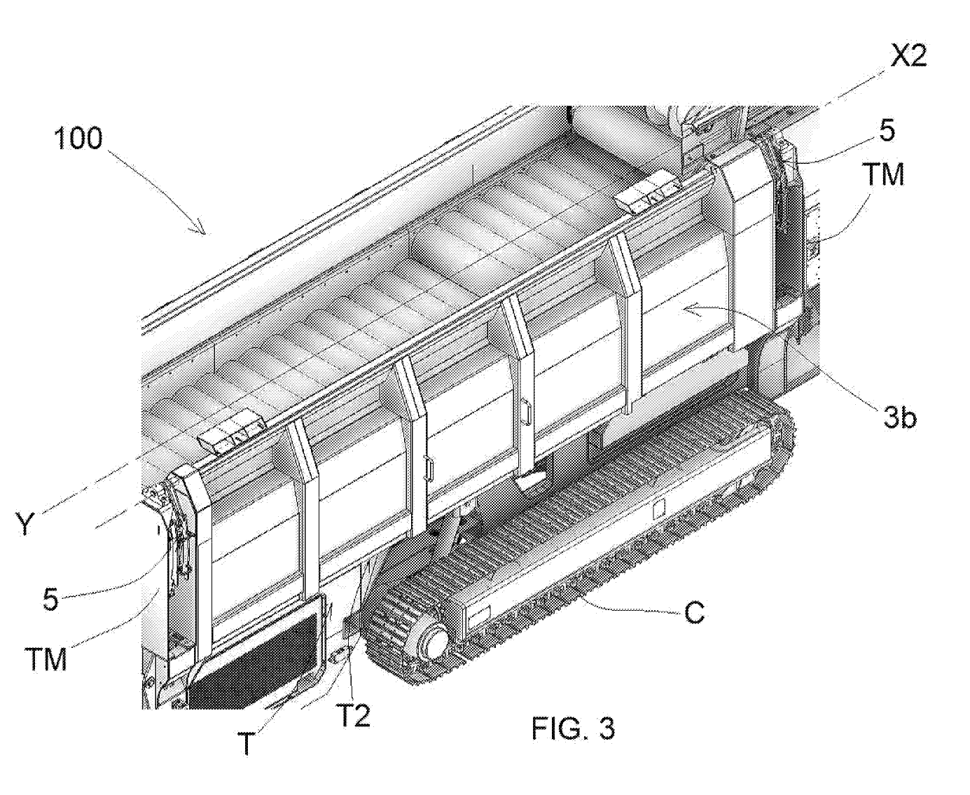

With reference to FIGS. 1, 2, 3, and 4, the screening machine (100) comprises a frame (T) having a longitudinal axis (Y) and comprising a first side (T1) and a second side (T2).

The screening machine (100) is preferably a mobile screening machine (100) and comprises transportation means (C) on which the entire frame (T) is mounted and which are positioned under the two sides (T1, T2) of the frame (T). The transportation means (C) consist in particular of tracks.

Each side (T1, T2) comprises a longitudinal member (TL) extending in parallel direction to the longitudinal axis (Y) of the frame (T) and two uprights (TM) positioned at the ends of the longitudinal member (TL). The uprights (TM) may be bolted or welded to the frame (T).

With reference to FIG. 6, the screening machine (100) comprises one or more screening modules (V1, V2, V3) connected to the frame (T).

In particular, in the embodiment shown in the attached figures, the screening machine (100) comprises three screening modules (V1, V2, V3), namely a first screening module (V1), a second screening module (V2) positioned downstream of the first screening module (V1), and a third screening module (V3) positioned downstream of the second screening module (V2).

With reference to FIGS. 6, 7, and 8, each screening module (V1, V2, V3) comprises a first lateral support (1a) positioned on the first side (T1) and a second lateral support (1b) positioned on the second side (T2), as well as a plurality of rollers (2) rotatably mounted between the two supports (1a, 1b). The rollers (2) are parallel and spaced apart from one another and are transverse, more precisely perpendicular, to the longitudinal axis (Y) of the frame (T). The rollers (2) define a screening surface (J) of the screening machine (100).

Each roller (2) has two ends (20) that are rotatably supported by support means (Q) fixed to the lateral support (1a, 1b). By way of example, the support means (Q) consist of bushings wherein bearings are mounted.

The first lateral support (1a) is connected to the longitudinal member (TL) of the first side (T1), whereas the second lateral support (1b) is connected to the longitudinal member (TL) of the second side (T2).

Each lateral support (1a, 1b) comprises an inner face (11) facing the other lateral support (1a, 1b) and from which the rollers (2) protrude, and an outer face (12) facing away from said inner face (11).

The rollers (2) are all rotated in the same direction of rotation by means of transmission means (6) located on the outer faces (12) of the first lateral supports (1a) of the screening modules (V1, V2, V3) and configured to transmit the motion of a motor (K1, K2) to said rollers (2).

Preferably, the transmission means (6) are configured such that all the rollers (2) of a single screening module (V1, V2, V3) rotate at the same speed.

The rotation of the rollers (2) allows the materials to travel forward in the screening machine (100).

In the attached Figures the rollers (2) are shown as spaced-apart cylindrical elements. The spaced-apart rollers (2) define a plurality of screen openings of the screening module (V1, V2, V3) located between the rollers (2), which are suitable for being traversed by materials having a size smaller than the screen openings.

Alternatively, the rollers (2) may be of any type known to a person skilled in the art and may consist of a shaft and a plurality of screening elements integral with the shaft, which protrude radially from the shaft and are spaced apart from one another. The screening elements may comprise hexagonal discs, octagonal discs, or star-shaped elements or similar elements.

The screening elements of a roller (2) are staggered relative to the screening elements of the adjacent roller (2) such that a plurality of screen openings of the screening module (V1, V2, V3) are formed between said screening elements, suitable for being traversed by materials having a size smaller than the screen openings.

Preferably, all the screen openings of a module (V1, V2, V3) are of the same size such that the screening module (V1, V2, V3) only screens materials having a size smaller than that of the screen openings.

Advantageously, each screening module (V1, V2, V3) has screen openings of different sizes compared to another screening module (V1, V2, V3). In particular, the screen openings of a screening module (V1, V2, V3) are larger than the screen openings of the upstream screening module (V1, V2, V3).

More precisely, the screen openings of the second screening module (V2) are larger than those of the first screening module (V1), and the screen openings of the third screening module (V3) are larger than those of the second screening module (V2).

The material is fed into the screening machine (100) by means of a feed hopper (not shown in the attached figures) located near the first screening module (V1) such that the material first passes through the first screening module (V1), then through the second screening module (V2), and finally through the third screening module (V3).

The rotation of the rotating rollers (2) of the various screening modules (V1, V2, V3) progressively moves the mass of material forward through the various modules (V1, V2, V3).

When the mass of material passes through the first screening module (V1), a portion of the material consisting of small particles passes through the openings of the first screening module (V1) and falls below the first screening module (V1).

When the mass of material passes through the second screening module (V2), a portion of the material consisting of medium-sized particles passes through the openings of the second screening module (V2) and falls below the second screening module (V2).

When the mass of material passes through the third screening module (V3), a portion of the material consisting of large particles passes through the openings of the third screening module (V3) and falls below the third screening module (V3).

The portion of material that has not passed through any openings of the screening modules (V1, V2, V3) exits the screening machine (100) and constitutes unscreened large-sized material.

Advantageously, conveyors may be associated with the screening machine (100), each one passing below a respective screening module (V1, V2, V3) and being suitable for collecting the material screened by the respective screening module (V1, V2, V3) that is transported to a dedicated unloading station.

Preferably, each screening module (V1, V2, V3) is removably mounted to the frame (1) so that each screening module (V1, V2, V3) can be disassembled and replaced with another screening module (V1, V2, V3), if necessary.

In particular, each lateral support (1a, 1b) of each screening module (V1, V2, V3) is removably connected to the respective longitudinal member (TL) of the side panel (T1, T2) of the frame (T) by means of threaded fasteners, such as bolts and the like.

With reference to FIGS. 7 and 8, preferably, each lateral support (1a, 1b) is of modular type and consists of a series of metal plates connected to one another by threaded fasteners, such as bolts.

In particular, each lateral support (1a, 1b) comprises:
a lower riser plate (13) secured to the longitudinal member (TL) of the side panel (T1, T2);
a support plate (14) for the rollers (2) secured to the lower riser plate (13) by means of threaded fasteners; the support plate (14) has holes for the insertion of the ends (20) of the rollers (2), and the support means (Q) for said rotatable rollers (2) are secured to the same support plate (14);
one or more cover plates (15) suitable for covering the top and the interior of the support plate (14); said cover plates (15) are connected to the support plate (14) by means of threaded fasteners.

The lower riser plate (13) can be of different height to determine the position of the support plate (14) and consequently the position of the rollers (2) of the screening modules (V1, V2, V3).

Since the lateral supports (1a, 1b) of the various screening modules (V1, V2, V3) must have the same height, the support plates (14) and the cover plates (15) will be appropriately sized to compensate for the different heights of the lower riser plates (13) of the screening modules (V1, V2, V3).

As shown in FIG. 6, the lower riser plates (13) of the two lateral supports (1a, 1b) of the first screening module (V1) have a greater height than the lower riser plates (13) of the lateral supports (1a, 1b) of the second and third screening modules (V2, V3), in such a way that the rollers (2) of the first screening module (V1) are positioned at a higher height than the rollers (2) of the second and third screening modules (V2, V3).

With reference to FIGS. 6, 7, and 8, preferably, each one of the two lateral supports (1a, 1b) of a screening module (V1, V2, V3) comprises at least two openings (A) aligned with the at least two openings (A) of the other lateral support (1a, 1b).

The openings (A) of the two lateral supports (1a, 1b) are suitable for being traversed by the arms of a conveyor fork.

In view of the above, once each lateral support (1a, 1b) has been disconnected from the respective underlying longitudinal member (TL), it is simply necessary to insert the fork arms into the openings (A) and then lift the entire screening module (V1, V2, V3) in order to transport it out of the screening machine (100).

With reference to FIGS. 9 and 9A, the transmission means (6) comprise rotating transmission members (61) fixed to the ends (20) of the rollers (2) and flexible transmission members (21) coupled to said rotating transmission members (61).

By way of example, the rotating transmission members (60) consist of gear wheels, and said flexible transmission members (61) comprise chains meshing with said gear wheels.

In particular, in the embodiment of the invention, for each rotating roller (2), the transmission means (6) comprise two rotating transmission members (60) fixed to one end (20) of the roller (2) and arranged one behind the other.

In this embodiment, furthermore, the transmission means (6) comprise a plurality of closed flexible transmission members (61) that embrace and mesh with two adjacent rotating transmission members (60).

A single motor (K1) may drive the transmission means (6) of a screening module (V1), or a single motor (K2) may drive the transmission means (6) of multiple interconnected screening modules (V2, V3). The connection of the transmission means (6) of two different adjacent screening modules (V2, V3) can be made by means of an additional flexible transmission member (62) that embraces and meshes with two adjacent rotating transmission members (60) fixed to the ends of two rollers (2) of adjacent screening modules (V2, V3).

In the version shown in the attached figures, the transmission means (6) of the first screening module (V1) are driven by a motor (K1), whereas the transmission means (6) of the second screening module (V2) and the third screening module (V3) are interconnected and driven by another motor (K2).

In both cases, the motor (K1, K2) drives the transmission means (6) of one or more modules via a motor transmission system (7).

The motor transmission system (7) comprises a drive sprocket (70) connected to a shaft of the motor (K1, K2), a return sprocket (71) fixed to one end (20) of one of the rollers (2), and a closed-loop chain (72) that embraces and meshes with the two sprockets (70, 71).

When the motor (K1, K2) is operated, the motor transmission system (7) is driven, causing the rotation of the roller (2) to which the idler sprocket (71) is attached.

In turn, the rotation of the roller (2) drives the transmission means (6), thereby causing the simultaneous rotation of the rollers (2).

With reference to FIGS. 1, 2, 3, 4, 2A, 2B, 4A, 4B, 5, 10, and 11, the screening machine (100) comprises a first movable bulkhead (3a) and a second movable bulkhead (3b) mounted movably on the first side (T1) and the second side (T2), respectively, such that they can alternately assume a lowered position, shown in FIGS. 1, 3, and 10, in which each movable bulkhead (3a, 3b) covers the outer face (12) of the lateral supports (1a, 1b) of the modules (V1, V2, V3) located on the same side panel (T1, T2), and a raised configuration, shown in FIGS. 2, 4, and 11, in which each movable bulkhead (3a, 3b) does not cover the outer face (12) of the lateral supports (1a, 1b) of the modules (V1, V2, V3) located on the same side (T1, T2).

Each movable bulkhead (3a, 3b) does not touch the upper edges of the lateral supports (1a, 1b) either when in lowered configuration or raised configuration.

With reference to FIGS. 2, 2A, 4, and 4A, each movable bulkhead (3a, 3b) has a quadrangular shape with an upper longitudinal edge (31), a lower longitudinal edge (32), and two lateral end edges (33).

Each movable bulkhead (3a, 3b) is hinged to the uprights (TM) of the respective side panel (T1, T2) about a rotation axis (X1, X2) located above the lateral supports (1a, 1b) of the screening modules (V1, V2, V3).

In this regard, the uprights (TM) of each side panel (T1, T2) comprise revolving connection means (41) aligned with one another along the axis of rotation (X1, X2) about which the movable bulkhead (3a, 3b) rotates.

Conversely, each movable bulkhead (3a, 3b) comprises pivoting means (42) pivotally coupled to said revolving connection means (41) and suitable for rotating the movable bulkhead (3a, 3b) about the axis of rotation (X1, X2).

In particular, said revolving connection means (41) comprise eyelets (410) formed at the top of the uprights (TM), whereas said pivoting means (42) comprise rotation pins (420) coaxial with one another that protrude from the lateral end edges (33) arranged at the upper longitudinal edge (31) and rotatably inserted into said eyelets (410) formed at the top of the uprights (TM).

Preferably, the axis of rotation (X1, X2) is spaced from the lateral supports (1a, 1b) of the screening modules (V1, V2) by a distance (D) greater than 30 cm.

In particular, in the preferred embodiment of the invention, the distance (D) between the lateral supports (1a, 1b) of the screening modules (V1, V2, V3) and the axis of rotation (X1, X2) about which the movable bulkhead (3a, 3b) rotates is greater than 40 cm.

The distance (D) between the axis of rotation (X1; X2) and the lateral supports (1a, 1b) is shown in FIG. 11.

With reference to FIGS. 1, 2, 3, and 4, the screening machine (100) comprises driving means (5) for each movable bulkhead (3a, 3b), configured to move the respective movable bulkhead (3a, 3b) between the lowered position and the raised position.

The driving means (5) are configured to rotate the respective movable bulkhead (3a, 3b) such that:
when the movable bulkhead (3a, 3b) is in lowered position, the movable bulkhead (3a, 3b) is positioned vertically to cover both the outer faces (12) of the lateral supports (1a, 1b) and the space (S) formed between the lateral supports (1a, 1b) of the screening modules (V1, V2, V3) and the axis of rotation (X) of the movable bulkhead (3a, 3b); and
when the movable bulkhead (3a, 3b) is in raised position, the movable bulkhead (3a, 3b) is positioned at an angle and protrudes outward, leaving free access both to the outer faces (12) of the lateral supports (1a, 1b) and to the space (S) formed between the lateral supports (1a, 1b) of the screening modules (V1, V2, V3).

With reference to FIG. 5, the driving means (5) are preferably configured to rotate the movable bulkhead (3a, 3b) by an angle (α) greater than 90°, so that the space (S) formed between the axes of rotation (X1, X2) is completely free and accessible to a user standing on one side of the screening machine (100) when the movable bulkhead is in raised position.

In particular, the driving means (5) are configured to rotate the movable bulkhead (3a, 3b) by an angle (α) between 100° and 125°, preferably 115°.

For each movable bulkhead (3a, 3b), the driving means (5) comprise two cylinder-piston assemblies, each one connected on one side to a respective upright (TM) and on the other side to the movable bulkhead (3a, 3b).

Each cylinder-piston assembly is hinged on one side to the respective upright (TM) and on the other side to a connecting rod (39) that extends radially from the rotation pin (420) of the pivoting means (42).

Each cylinder-piston assembly comprises a cylinder hinged to the upright (TM) and a piston that slides relative to the cylinder and is hinged to the connecting rod (39).

The cylinder-piston assembly is preferably a hydraulic cylinder-piston assembly.

With reference to FIGS. 1, 2, 3, and 4, each upright (TM) is advantageously box-shaped and defines a cavity open to the outside.

Each cylinder-piston unit of the driving means (5) is inserted into the housing of the respective upright (TM) so that the stepped upright acts as a guard for the cylinder-piston unit.

Now with reference to FIGS. 2A, 2B, 4A, 4B, 10, and 11, in each movable bulkhead (3a, 3b) the following can be identified:
an upper portion (3s) that terminates at the top with said upper longitudinal edge (31) and is suitable for being positioned in the space (S) formed between the axis of rotation (X1, X2) and the lateral supports (1a, 1b) of the screening modules (V1, V2, V3) when the movable bulkhead (3a, 3b) is in lowered position; and
a lower portion (3i) that terminates inferiorly at said lower longitudinal edge (32) and is suitable for covering the outer face (12) of the lateral supports (1a, 1b) of the screening modules (V1, V2, V3) when the movable bulkhead (3a, 3b) is in raised position.

Thus, when the movable bulkhead (3a, 3b) is in lowered position, the upper portion (3s) of each movable bulkhead (3a, 3b) serves as a containment edge for the screening machine (100) in order to prevent the material that is moved forward along the screening modules (V1, V2, V3) and is accidentally thrown by the rotating rollers (2) from exiting the screening machine (100), hitting or injuring any operators located in the vicinity of the screening machine (100).

The upper portion (3s) of each movable bulkhead (3a, 3b) also has an inner face (30s) facing the rollers (2), suitably shaped and configured to convey the material thrown by the rollers (2) back towards the rollers (2) so that the material does not settle on the lateral supports (1a, 1b) or, worse still, lodge between the movable bulkhead (3a, 3b) and the outer face (12) of the lateral supports (1a, 1b), thereby interfering with the transmission means (6) or the motors (K1, K2) and consequently causing failures and malfunctions in the screening machine (100).

In the specific embodiment of the invention, the inner face (30s) of the upper portion (3s) is flat, and when the movable bulkhead (3a, 3b) is in lowered position, the inner face (30s) of the upper portion (3s) of the movable bulkhead (3a, 3b) is coplanar with the inner faces (11) of the lateral supports (1a, 1b) of the screening modules (V1, V2, V3).

In the embodiment shown in the attached figures, each movable bulkhead (3a, 3b) is made in a single monolithic piece.

Alternatively, said movable bulkhead (3a, 3b) may also be of the modular type, i.e., composed of a series of elements that can be coupled together. A movable bulkhead (3a, 3b) of the modular type is versatile and adaptable to different sizes of screening machines (100).

With reference to FIG. 12, the screening machine (100) comprises a control unit (81) operatively connected to said driving means (5) and to said motors (K1, K2) to actuate said driving means (5) and activate or deactivate motors (K1, K2).

The screening machine (100) further comprises a user device (82) operatively connected to said control unit (81) and configured such that it can be used by an operator to give commands to the control unit (81) to control said driving means (5) and said motors (K1, K2).

By way of example, the user device (82) comprises a push-button panel connected by means of wires to the control unit (81) or a smart device connected wirelessly to the control unit (81).

Advantageously, the machine (100) further comprises sensors (9) configured to detect the position of each movable bulkhead (3a, 3b) and operatively connected to the control unit (81) to transmit information regarding the position of each movable bulkhead (3a, 3b).

The control unit (81) is configured to block and prevent the activation of the motors (K1, K2) when one or both of the movable bulkheads (3a, 3b) is or are in raised position. In this way, the control unit (81) functions as a safety system.

Following the preceding description, the advantages of the present invention achieved with the provision of the new movable bulkheads (3a, 3b) hinged to the sides (T1, T2) of the frame (T) of the screening machine (100), are now evident.

When the movable bulkheads (3a, 3b) are in lowered position, the movable bulkheads (3a, 3b) perform the following functions:
they cover the lateral supports (1a, 1b) from the outside so that a user cannot access the transmission means (6) and the motors located outside the lateral supports (1a);
they cover the space (S) formed between the rotation axis (X1, X2) and the underlying lateral supports (1a, 1b) acting as a protective cover for the screening machine (100).

When, on the other hand, the movable bulkheads (3a, 3b) are in raised position, they allow a user to:
access the outer faces (12) of the lateral supports (1a, 1b) to perform inspection or maintenance operations on the transmission means (6) and motors (K1, K2), or disconnect the lateral supports (1a, 1b) from the underlying longitudinal member (TL) to remove the screening module (V1, V2, V3) from the frame (T);
access the screening surface (J) defined by the rollers (2) by passing through the space (S), for example to remove material stuck between the rollers (2).

By ensuring that the distance (D) between the axis of rotation (X1, X2) of the movable bulkhead (3a, 3b) and the underlying lateral supports (1a, 1b) is greater than 30 cm, a significantly wide and convenient lateral space (S) giving access to the rollers (2) is provided.

Although in the attached figures the screening machine (100) comprises a plurality of screening modules (V1, V2, V3), specifically three, in an alternative embodiment of the invention, the screening machine (100) may also comprise a single screening module or a number of screening modules other than three.

Numerous variations and detailed modifications may be made to the present embodiment of the invention, within the skill of a person skilled in the art, which nevertheless fall within the scope of the invention as defined by the appended claims.

What is claimed is:

1. Screening machine comprising:
a frame comprising a first side and a second side; wherein each side comprises a longitudinal member and two uprights positioned at the ends of the longitudinal member;
at least one screening module comprising a first lateral support connected to the longitudinal member of the first side, a second lateral support connected to the longitudinal member of the second side, and a plurality of rollers rotatably mounted between the two lateral supports so as to define a screening surface;
transmission means located on an outer face of the first lateral support and connected to at least one motor and to the rollers to rotate said rollers in the same direction of rotation;
a first movable bulkhead and a second movable bulkhead movably mounted respectively on the first side and on the second side so as to be disposed in a lowered position, wherein a movable bulkhead covers the outer face of the lateral support of the screening module, and in a raised position, wherein a movable bulkhead does not cover the outer face of the lateral support of the screening module;
driving means for each movable bulkhead configured to move the respective movable bulkhead between the lowered position and the raised position;
wherein each movable bulkhead does not touch the upper edges of the underlying lateral support;
wherein each movable bulkhead is hinged to the uprights of the side around an axis of rotation located above the lateral support of the at least one screening module;
wherein said driving means are configured to rotate the movable bulkhead in such a way that:
when the movable bulkhead is in lowered position, the movable bulkhead is positioned vertically to cover both the outer face of the lateral support of the at least one module and the space formed between the lateral support and the axis of rotation; and
when the movable bulkhead is in raised position, the movable bulkhead is inclined and protrudes outwardly, leaving free access to the outer face of the lateral support and to the space formed between the lateral support and the axis of rotation.

2. The screening machine of claim 1, wherein the uprights of each side comprise revolving connection means aligned along the axis of rotation about which the movable bulkhead rotates; wherein each movable bulkhead comprises pivoting means rotatably coupled to said revolving connection means suitable for rotating the movable bulkhead about the axis of rotation.

3. The screening machine of claim 2, wherein said revolving connection means comprise eyelets formed at the top of the uprights and said pivoting means comprise rotation pins coaxial with each other and rotatably inserted into said eyelets formed at the top of the uprights.

4. The screening machine of claim 1, wherein the axis of rotation is spaced from the lateral support of the at least one screening module by a distance higher than 30 cm.

5. The screening machine of claim 4, wherein said distance between the axis of rotation and the lateral supports is higher than 40 cm.

6. The screening machine of claim 1, wherein said driving means are configured to rotate the movable bulkhead by an angle greater than 90°.

7. The screening machine of claim 1, wherein, for each movable bulkhead, the driving means comprise two cylinder-piston assemblies, each cylinder-piston assembly being connected to a respective upright on one side and to the movable bulkhead on the other side.

8. The screening machine of claim 7, wherein each upright is boxed and defines a seat that is open outwardly; wherein each cylinder-piston assembly of the driving means is disposed in the seat of the respective upright.

9. The screening machine of claim 1, wherein each lateral support of each screening module is removably connected to the respective longitudinal member of the side of the frame by means of threaded connection means.

10. The screening machine of claim 9, wherein each of the two lateral supports of a screening module comprises at least two openings aligned with the at least two openings of the other lateral support; wherein said openings are suitable for being traversed by the arms of a conveyor fork.

11. The screening machine of claim 1, wherein each roller comprises a shaft, a plurality of screening elements integral with the shaft that project radially from the shaft and are spaced from each other; wherein the screening elements of a roller are staggered with respect to the screening elements of an adjacent roller in such a way that a plurality of screen openings is formed between said screening elements, said screen openings being suitable for being traversed by materials having a smaller size than the screen openings.

12. The screening machine of claim 1, comprising a plurality of screening modules connected to the frame.

13. The screening machine of claim 1, comprising:
a control unit operatively connected to said driving means and said at least one motor for actuating said driving means and activating/deactivating said at least one motor; and
sensors configured to detect the position assumed by each movable bulkhead and operatively connected to the control unit to transmit information on the position assumed by each movable bulkhead;
wherein said control unit is configured to block and prevent the activation of the motors when one and/or both movable bulkheads is/are in raised position.
